(19) United States
(12) Patent Application Publication
(10) Pub. No.: US 2014/0013876 A1
(43) Pub. Date: Jan. 16, 2014

(54) ACTUATING DEVICE FOR A LOCKING DEVICE OF AN ADJUSTING DEVICE OF A MOTOR VEHICLE SEAT

(71) Applicant: Ingo Quast, Coburg (DE)

(72) Inventor: Ingo Quast, Coburg (DE)

(21) Appl. No.: 13/981,199

(22) PCT Filed: Jan. 18, 2012
(86) PCT No.: PCT/EP2012/000195

§ 371 Date: Sep. 20, 2013

(30) Foreign Application Priority Data
Jan. 24, 2011 (DE) 10 2011 003 052.2

(51) Int. Cl. B60N 2/08

(52) U.S. Cl. CPC B60N 2/0881
USPC 74/89; 29/428

(57) ABSTRACT

An actuating device for a locking means of a longitudinal adjusting means of a motor vehicle seat with upper and lower rails engaging in each other and longitudinally adjustable relative to each other, between which a cavity is formed, is provided. The actuating device comprises actuating elements for unlocking the locking means pretensioned in locking direction. The actuating elements are combined to a functional assembly which can be inserted into the cavity between the upper and lower rails, is connectable with the locking means and can be brought into an operating position for actuating the locking means on insertion into the cavity between the upper and lower rails and connection with the locking means.

### CROSS-REFERENCE TO A RELATED APPLICATION

This application is a National Phase Patent Application of International Patent Application Number PCT/EP2012/000195, filed on Jan. 18, 2012, which claims priority of German Patent Application Number 10 2011 003 052.2, filed on Jan. 24, 2011.

### BACKGROUND

This invention relates to an actuating device for a locking means of an adjusting device of a motor vehicle seat and to a method for manufacturing a preassembled functional assembly of the actuating device and for mounting the preassembled functional assembly in a longitudinal adjusting means for a motor vehicle seat.

From DE 10 2007 027 321 A1 there is known a locking device for a rail adjustment system of a vehicle seat with three locking bolts arranged one behind the other, which in vertical direction, i.e. in inverse Z-direction of a motor vehicle system of coordinates, are adjustable from an unlocked position into a locked position. The locking bolts extend through a supporting plate and the upper rail of the rail adjustment system, on which the supporting plate rests, into bores formed for this purpose. Pretensionable spring elements, which enclose the locking bolts and on the one hand rest against the supporting plate and on the other hand are jammed in a groove each of a locking bolt, build up a restoring force acting on the locking bolts in the locking direction.

An unlocking comb pivotally articulated to the supporting plate, which has fork-like extensions engaging behind the upper ends of the locking bolts, serves to lift the locking bolts against the restoring force of the spring elements from the locked position into an unlocked position, i.e. in unlocking direction or Z-direction of the motor vehicle system of coordinates. For this purpose, the unlocking comb has an actuating surface which can be actuated in unlocking direction, i.e. in Z-direction of the motor vehicle system of coordinates, by a vertically oriented unlocking pin of an actuating device consisting of the unlocking pin and a cam unlocker. The unlocking pin exerts a force on the actuating surface which is greater than all forces driving the unlocking comb in locking direction, in particular greater than the sum of the restoring forces exerted on the locking bolts by the spring elements.

On its bottom side, the unlocking pin has a broadened contact surface with which the unlocking pin is standing on an eccentric surface integrally molded in a cylindrical cam unlocker. The cam unlocker is pivotally mounted about an axis of rotation by substantially 180°, wherein the axis of rotation is aligned parallel to the Y-direction of the motor vehicle system of coordinates. Due to the shape of the eccentric surface of the cam unlocker, the unlocking pin resting on the eccentric surface is guided in locking direction or urged in the unlocking direction during a swivel movement of the cam unlocker.

The actuating device for unlocking the locking bolts by pivoting the unlocker comb of the known locking device for a rail adjustment system must be connected with the rail adjustment system in several working steps by using blind rivets and supporting plates and must be aligned with the unlocking device in a suitable way.

### SUMMARY

It is the object underlying the present invention to assemble an actuating device for a locking means of an adjusting device of a motor vehicle seat as mentioned above of few components, which can be inserted into the adjustment device and be connected with the locking means without additional parts in only one working step.

The solution according to an exemplary embodiment of the invention provides an actuating device for a locking means of an adjusting device of a motor vehicle seat as mentioned above, which consists of few components and without additional parts in only one working step can be inserted into the adjusting device, can be connected with the locking means, and can be brought into an operating position for actuating the locking means.

The provision of a functional or preassembled group simplifies the mounting of the actuating device into an adjusting device, in that on insertion into the adjusting device and connection with the locking means the functional assembly is brought into the operating position for actuating the locking means.

Preferably, the actuating elements in the functional assembly are pretensioned and locked in the pretensioned position, so that on connection of the functional assembly with the locking means the locking of the actuating elements is canceled and the pretension of the actuating elements is released when the functional assembly takes its operating position.

In an actuating device for a longitudinal adjusting means of a motor vehicle seat with upper and lower rails engaging in each other and longitudinally adjustable relative to each other, between which a cavity is formed, the functional assembly is inserted into the cavity between the upper and lower rails and brought into the operating position.

When the longitudinal adjusting means of the motor vehicle seat as mentioned above includes a locking means with a number of locking bolts pretensioned in locking direction of the upper and lower rails and an unlocker comb pivotable about a pivot pin, which for unlocking the locking bolts by means of the unlocking pin is pivotable in an unlocking position of the locking bolts, the actuating device can consist of a manually or electromotively actuatable unlocking lever, which can lift the unlocker comb from the locking position against the spring pretension of the locking bolts. Alternatively, the actuating elements can include an unlocking pin for unlocking the locking means pretensioned in locking direction, a cylindrical cam unlocker with integrally molded eccentric surface for actuating the unlocking pin, and a leg spring placed around the cam unlocker, which are combined in a housing to form the functional assembly, which for taking the operating position is insertable into the cavity between the upper and lower rails along with the locking means.

In this embodiment of an actuating device for a locking means of a rail adjustment system of a motor vehicle seat, the functional or preassembled group merely is inserted into the upper rail, positively connected with the upper rail by depressing the same, and the unlocking pin thereby is brought in position, whereby the operability of the rail adjustment system already is established. Subsequently, as also in the above-mentioned prior art, there must merely be established a connection between the cam unlocker and an operating lever, for example via a Bowden cable.

When the actuating device includes a manually or electromotively actuatable unlocking lever, which lifts the unlocker comb from the locking position against the spring pretension, the unlocking lever instead of the unlocking pin can be accommodated in the functional assembly or be actuated by the unlocking pin.

Mounting the functional or preassembled group likewise is very easy, as merely the leg spring must be connected with the cam unlocker, the cam unlocker with the leg spring must be inserted into a corresponding recess of the housing, the unlocking pin must be inserted, and the cam unlocker with the unlocking pin is locked in a preassembly position by a screwing movement of the cam unlocker, during which the cam unlocker is fixed at the housing, wherein the leg spring is tensioned by the screwing movement of the cam unlocker, so that the functional elements of the functional or preassembled group are pretensioned in the preassembly position.

For establishing the preassembly position, the cam unlocker is mounted on a first side wall of the housing with a rear end face and for adjusting the preassembly position the rear end face of the cam unlocker is connectable with the first side wall of the housing with a radially and axially directed screwing movement against the spring force of the leg spring and is mutually locked with the unlocking pin aligned vertically to the axis of the cylindrical cam unlocker, which during the screwing movement of the cam unlocker is moved from an operating position into a coulisse receptacle, wherein the unlocking pin blocks a rotation of the cam unlocker against the screwing movement connecting the cam unlocker with the first side wall of the housing and a trunnion formed on a front end face opposite the rear end face of the cam unlocker terminates at least flush with the second side wall opposite the first side wall of the housing.

A first spring leg of the leg spring is connected with the cam unlocker, and in the preassembly position a second spring leg of the leg spring rests against a first spring leg stop of the housing, while for establishing the preassembly position the leg spring is tensioned by means of the screwing movement of the cam unlocker.

For connecting the cam unlocker with the housing, the rear end face of the cam unlocker and the first side wall of the housing include form-fit elements and counter form-fit elements engaging in each other for axially and radially fixing the cam unlocker, which are formed in the manner of a bayonet lock, preferably with rear grip, which by a screwing movement of the cam unlocker is closed in the one direction of rotation and is opened in the opposite direction of rotation. Further form-fit elements and counter form-fit elements consist of screw surfaces on the first side wall of the housing and counter screw surfaces cooperating with the screw surfaces on the rear end face of the cam unlocker.

In the preassembly position, the actuating head of the unlocking pin opposite the actuating tip of the unlocking pin rests against a spring tab of the housing, so that in the preassembly position the unlocking pin is pretensioned in direction of an engagement into the upper rail.

The housing of the functional or preassembled group includes
a trunnion accommodating the cam unlocker on the first side wall,
the form-fit elements radially spaced from the trunnion for connection with the counter form-fit elements of the rear end face of the cam unlocker,
adjacent to a first end face of the housing a connecting pin protruding from the bottom to be connected with an adjustable part of the adjusting device, which in the operating position of the actuating device engages into an opening of the adjustable part,
a second spring stop against which the second spring leg of the leg spring rests in the operating position of the actuating device,
a preferably bent spring tab partly enclosing the shell surface of the cam unlocker,
an insertion bevel between the bottom wall and the second end wall opposite the first end wall, and
a stop protruding from the upper side adjacent to the first end wall.

The cam unlocker of the functional or preassembled group includes
the bearing bore on the rear end face, which together with the trunnion of the housing forms a pivot bearing of the cam unlocker,
the counter form-fit elements spaced from each other radially from the bearing bore and in circumferential direction of the rear end face for connection with the form-fit elements on the first side wall of the housing,
a bore arranged in the peripheral surface for accommodating the first spring leg of the leg spring, and
circumferential limiting webs axially spaced from each other in the peripheral surface, which between themselves form the cylindrical spring bearing for accommodating the leg spring.

For preassembly of the functional or preassembled group of the actuating device
the cam unlocker with the leg spring put onto the spring bearing is put into the pot-like recess of the housing formed between the side walls of the housing,
the unlocking pin is inserted into the between the wall of the recess and the integrally molded eccentric surface of the cam unlocker via an insertion bevel of the housing, and
by means of a screwing movement the cam unlocker is connected with the first side wall of the housing by the connection of the form-fit elements and counter form-fit elements and locked in the preassembly position by mutually blocking with the unlocking pin.

For mounting the premounted functional or preassembled group of the actuating device into a longitudinal adjusting means for a motor vehicle seat, which contains upper and lower rails engaging in each other and longitudinally adjustable relative to each other, with a locking and unlocking means which includes a number of locking bolts pretensioned in locking direction of the upper and lower rails and an unlocking comb pivotable about a swivel axis, which for unlocking the locking bolts by means of the unlocking pin can be pivoted into an unlocking position of the locking bolts,
the functional assembly is inserted into the upper rail until abutment of the stop of the housing against a part (steel guide piece) of the upper rail,
the unlocking pin is moved in direction of the upper side of the housing by pressure onto the front region of the housing adjoining the second end wall, against the spring force of the bent spring tab of the housing,
by further pressure onto the housing, the connecting pin engages into a clip hole of the upper rail and the trunnion of the cam unlocker is aligned with a bearing hole in a side wall of the upper rail,
with the linear movement, the unlocking pin leaves its blocking position in the coulisse receptacle,
due to the pretension of the leg spring in the preassembly position or by a tool engaging into the profiled structure in the front end face of the cam unlocker a torque is exerted on the cam unlocker in anticlockwise direction, wherein by canceling the blockage of the unlocking pin a rotary movement of the cam unlocker is effected in clockwise direction, which is triggered by the leg spring or the tool,
with the rotary movement of the cam unlocker opposite to the screwing movement of the cam unlocker for establishing the preassembly position, the form-fit elements and counter form-fit elements get out of engagement and release the cam unlocker,
the cam unlocker moves in Y-direction of the motor vehicle system of coordinates, and
the unlocking pin moves into the central plane of the housing, wherein the bent spring tab of the housing urges the unlocking pin in direction of a bearing hole for the unlocking pin in the upper rail.

In a second mounting step
the unlocking pin and the connecting pin are depressed by means of a pressing device attached in the region of the upper side of the housing and at the same time the cam unlocker is rotated in clockwise direction against the spring force of the leg spring enclosing the cam unlocker, and
when being pressed into the bearing hole of the upper rail, the unlocking pin is threaded into the bearing hole in a movement similar to the shape of an S as a result of the eccentric surface of the cam unlocker resting against the actuating head of the unlocking pin, in which bearing hole it is in the locking position of the actuating device.

### BRIEF DESCRIPTION OF THE DRAWINGS

Further features and advantages of the invention will be explained with reference to the exemplary embodiment illustrated in the drawing.

FIG. 1 shows a perspective representation of a locking device for a rail adjustment system of a motor vehicle seat in the locked condition.

FIG. 2 shows a perspective representation of a locking device for a rail adjustment system of a motor vehicle seat in the unlocked condition.

FIG. 3 shows a perspective representation of a functional or preassembled group.

FIG. 4 shows a perspective representation of a functional assembly according to FIG. 3, which is mounted in the upper rail of a rail adjustment system.

FIGS. 5 and 6 show perspective exploded representations of the functional elements of the functional assembly according to FIGS. 3 and 4 from opposite views.

FIG. 7 shows a top view of the bottom of the mounted functional assembly in the preassembly condition.

FIG. 8 shows a top view of the bottom of the mounted functional assembly in the operating condition.

FIG. 9 shows a side view of the functional assembly on insertion into an upper rail of a rail adjustment system.

FIG. 10 shows a side view of the functional assembly during depression and creation of the operating condition.

FIG. 11 shows an enlarged representation of the engagement of a connecting pin of the functional assembly into a clip hole of the upper rail of the rail adjustment system.

FIG. 12 shows a perspective representation of the functional assembly in the operating condition.

### DETAILED DESCRIPTION

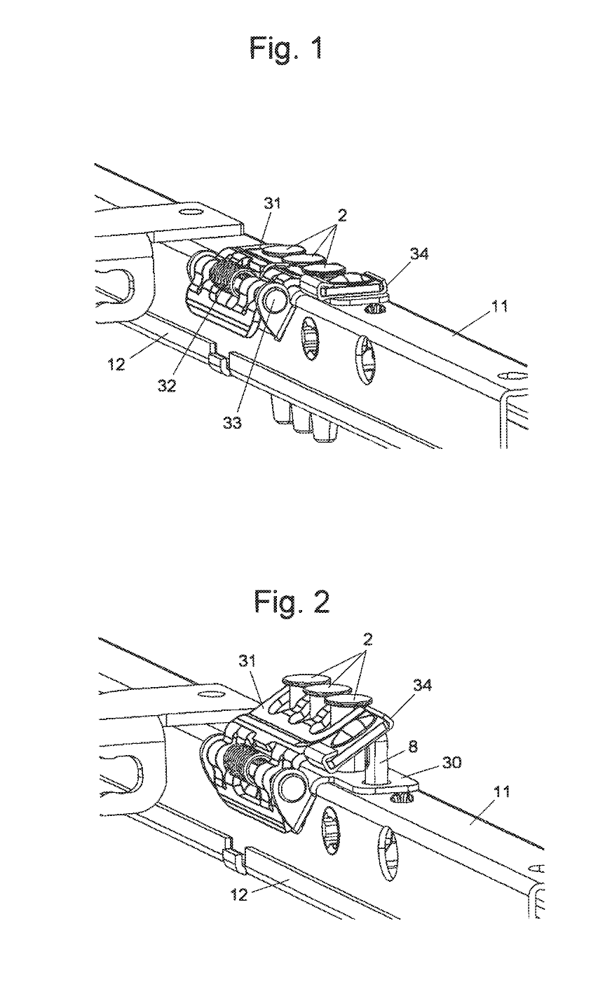

FIGS. 1 and 2 show perspective representations of a locking device for a rail adjustment system for longitudinal adjustment of a motor vehicle seat with an upper rail 11 connected with the motor vehicle seat and a body-mounted lower rail 12 in the locked condition (FIG. 1) and unlocked condition (FIG. 2). The locking device comprises three locking bolts 2 arranged one behind the other, which are adjustable in vertical direction from the locked position into the unlocked position. The locking bolts 2 are guided through bores of a supporting plate 30 and through bores of the upper rail 11 of the rail adjustment system, which are aligned therewith. Pretensionable spring elements, which enclose the locking bolts 2 and on the one hand are supported on the supporting plate 30 and on the other hand on a groove or other spring support of the locking bolts 2, build up a restoring force acting on the locking bolts 2 into the locking position shown in FIG. 1.

To the supporting plate 30 an unlocker comb 31 is pivotally articulated, which with fork-like cutouts engages behind the upper ends of the locking bolts 2 and by means of an actuating device lifts the locking bolts 2 from the locked position shown in FIG. 1 into the unlocked position shown in FIG. 2, against the restoring force of the spring elements enclosing the locking bolts 2. The unlocker comb 31 is mounted on the supporting plate 30 via a pivot pin 33 extending parallel to the longitudinal extension of the upper and lower rails 11, 12. A coil spring 32 encloses the pivot pin 33 for exerting a restoring force on the unlocker comb 31 in direction of the locked position of the locking device as shown in FIG. 1.

The unlocker comb 31 includes an actuating surface 34 which can be actuated by an unlocking pin 8 aligned parallel to the locking bolts 2 for unlocking the locking device. The unlocking pin 8 exerts a force on the actuating surface 34, which is greater than all forces acting on the unlocker comb 31 in locking direction, wherein the actuating surface 34 is enclosed by a template with a central recess engaging behind the same, in order to support the actuation-side end of the unlocking pin 8.

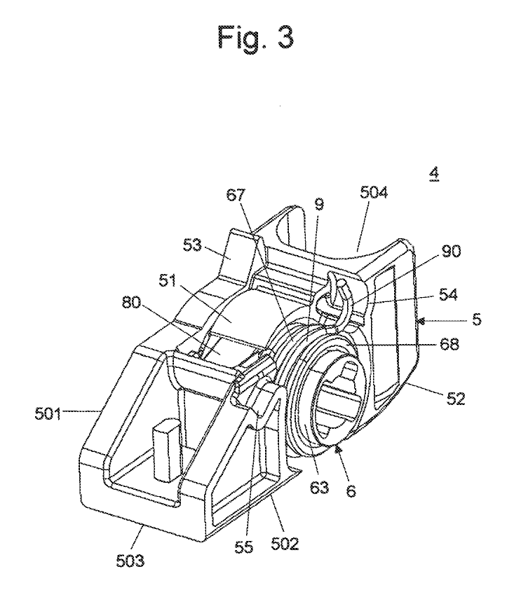

FIG. 3 shows a perspective view of a functional assembly 4 for actuating the unlocker comb 31 of FIGS. 1 and 2, and FIG. 4 shows the functional assembly mounted in the upper rail 11 for actuating the unlocker comb 31 by means of the unlocking pin 8 adjustable in direction of arrow.

The functional assembly 4 contains a housing 5, a cam unlocker 6 inserted into the housing 5, a leg spring 9 mounted on the cam unlocker 6, and the unlocking pin 8 actuatable by means of the cam unlocker 6. In the preassembled condition, the functional assembly 4 is inserted into the upper rail 11 as preassembled group and positively connected with the upper rail 11 such that the unlocking pin 8 is aligned with the actuating surface 34 or a guide surface of the unlocker comb 31 provided in the actuating surface 34, as shown in FIGS. 1 and 2.

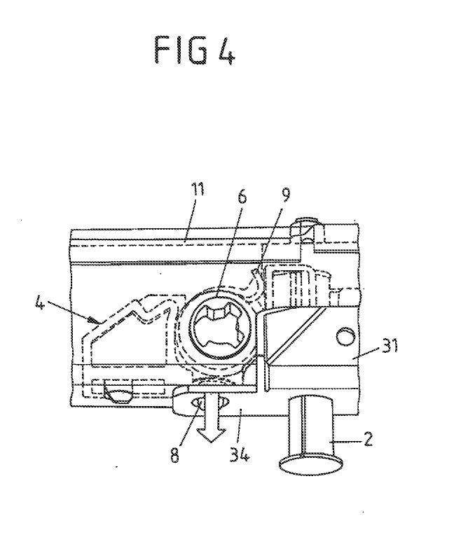

By introducing a rotary movement into the cam unlocker 6, the unlocking pin 8 is moved in direction of the arrow shown in FIG. 4 and the unlocker comb 31 thereby is pivoted, in order to lift the locking bolts 2 from the locked position shown in FIG. 4 into the unlocked position. For this purpose, a profiled structure 65 is provided in the front end face 61 of the cam unlocker 6, into which a correspondingly structured actuating element in the form of a lever, a cable pulley or the like engages, which via a Bowden cable is connected with an operating element, which for easy accessibility for example is arranged in the front region of the seat pan or seat base of a motor vehicle seat.

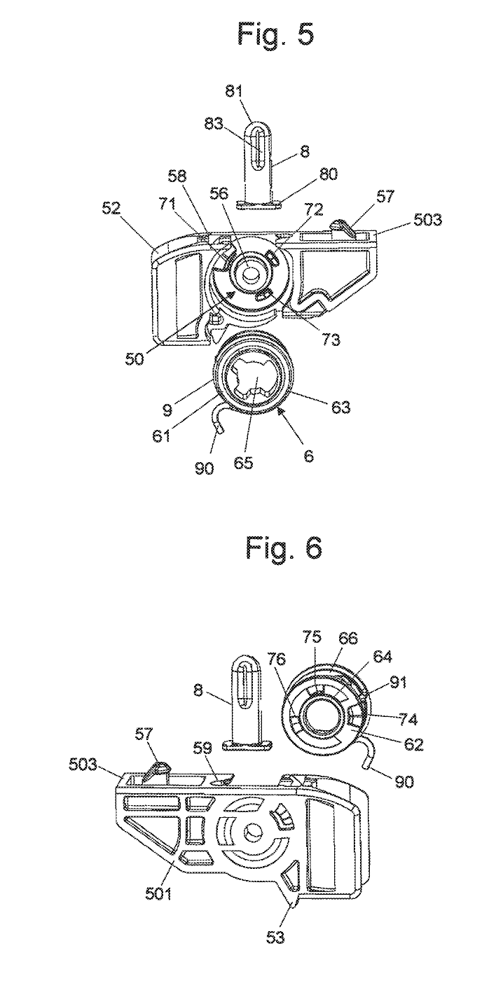

With further reference to FIGS. 3 to 8, the construction and function of the functional assembly 4 for actuating the locking device will now be explained in detail below.

The housing 5 of the functional assembly 4 is formed approximately trapezoidal in a longitudinal section and includes two parallel side walls 501, 502 and a bottom wall 503, which for inserting the functional assembly 4 into the upper rail 11 of FIG. 4 has an insertion radius 52 at a second end wall 504 of the housing 5. The housing 5 contains a pot-like recess 50 into which the cam unlocker 6 can be inserted and in a preassembly position can be positively connected and locked with the one side wall 501 of the housing 5.

The housing 5 furthermore includes a first spring leg stop 54 for a first spring leg 90 of the leg spring 9, which is arranged on a spring bearing 69 between two circumferential limiting webs 67, 68 at the circumference of the cam unlocker 6 and with its second spring leg 91 is fixed at the cam unlocker 6 for example by inserting the second spring leg 91 into a bore of the cam unlocker 6. The abutment surface of a second spring leg stop 55 opposite the first spring leg stop is adapted to the shape of the angled first spring leg 90 of the leg spring 9, so that the free end of the first spring leg 90 can rest flat against the abutment surface of the second spring leg stop 55.

On the upper side of the housing 5 a stop 53 is provided, which—as will be explained in detail below—in conjunction with the insertion radius 52 at the bottom wall 503 of the housing 5 facilitates the insertion or threading of the functional assembly 4 into an upper rail of a rail adjustment system. The housing 5 furthermore includes a bent spring tab 51 on its upper side, which in the preassembly position of the functional assembly 4 holds the unlocking pin 8 in position and pretensions the same on insertion into the upper rail.

The cam unlocker 6 includes an eccentric surface 66 which in the operating position of the functional assembly 4 cooperates with the actuating head 80 of the unlocking pin 8 and during a rotation of the cam unlocker 6 lifts or lowers the unlocking pin 8 and correspondingly pivots the unlocker comb 31 via the actuating tip 81 of the unlocking pin 8 engaging the actuating surface 34 of the unlocker comb 31 into the unlocked or locked position of the locking bolts 2 as shown in FIGS. 1 and 2.

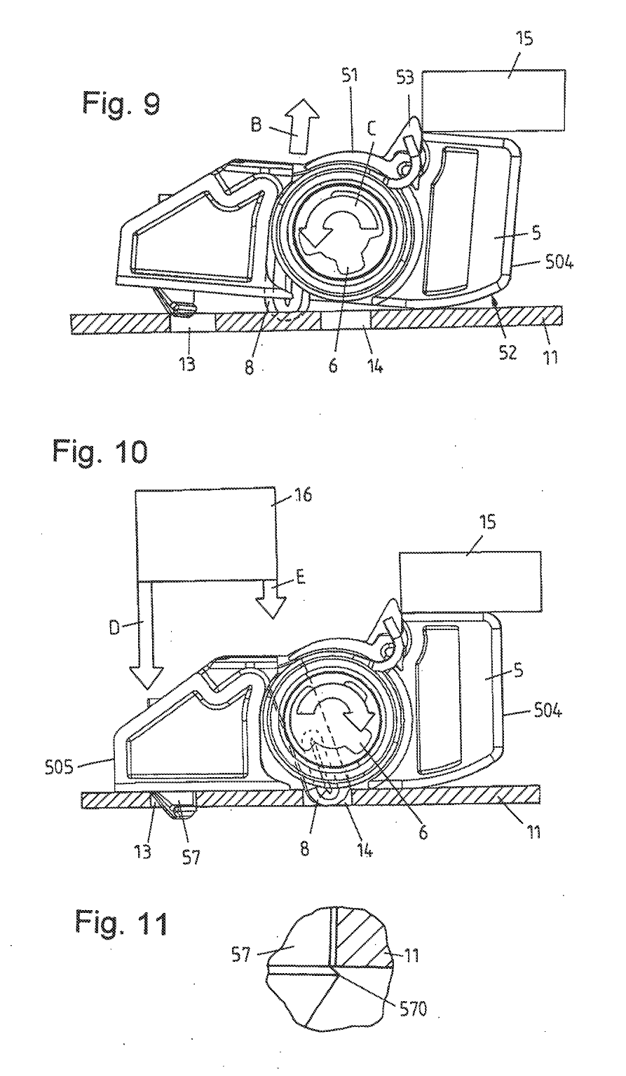

On the bottom wall 503 of the housing 5, spaced from the pot-like recess 50 of the housing 5, a connecting pin 57 is arranged, which protrudes from the bottom wall 503 and on insertion of the functional assembly 4 into the upper rail 11 of a rail adjustment system according to FIGS. 9 and 10 engages into a clip hole 13 of the upper rail 11. An insertion bevel 58 serves for inserting the unlocking pin 8 into the region between the wall of the pot-like recess 50 and the cam unlocker 6, so that in the rest condition of the operating position of the functional assembly 4, i.e. in the locked position of the locking means, the actuating head 80 of the unlocking pin 8 rests on a shoulder at the insertion bevel 58.

On the side wall 501 of the housing 5, which defines the pot-like recess 50, a trunnion 56 is formed, which accommodates a bearing bore 64 on the rear end face 62 of the cam unlocker 6, so that the cam unlocker 6 is rotatably arranged in the pot-like recess 50 of the housing 5. On the front end face 61, a trunnion 63 serves for connection with a bearing bore in a side wall of the upper rail 11 of the rail adjustment system.

For establishing and securing the preassembly position of the functional assembly 4, form-fit elements 71 to 73 arranged radially spaced from the trunnion 56 are provided, which cooperate with counter form-fit elements 74 to 76 on the rear end face 62 of the cam unlocker 6 for axially and radially fixing the cam unlocker 6. The form-fit element 71 and the counter form-fit element 74 are formed in the manner of a bayonet lock which is closed by a screwing movement of the cam unlocker 6 in the one direction of rotation and is opened in the opposite direction of rotation, for which purpose the form-fit element 71 at the housing 5 and the counter form-fit element 74 at the cam unlocker 6 have an undercut. The form-fit elements 72, 73 at the housing 5 and the corresponding counter form-fit elements 75, 76 at the cam unlocker 6 are designed as cam mechanism and on insertion of the functional assembly into the upper rail 11 and threading of the trunnion 63 into the bearing bore in a side wall of the upper rail 11 of the rail adjustment system act to prevent jamming of the cam unlocker 6 and hence of the trunnion 63. The form-fit elements 71 to 73 and counter form-fit elements 74 to 76 thus form screw surfaces for securing the preassembly position, which allow an exact positioning of the cam unlocker 6 even under the influence of the spring force acting on the unlocking pin 8.

In the operating position, the cam unlocker 6 is rotatably supported on the trunnion 56 by means of the bearing bore 64, so that the form-fit elements 71 to 73 and counter form-fit elements 74 to 76 only are active in an initial region, which is necessary for assembly, and the further support of the cam unlocker 6 is ensured by the support of the bearing bore 64 on the trunnion 56 in Y-direction of the motor vehicle system of coordinates.

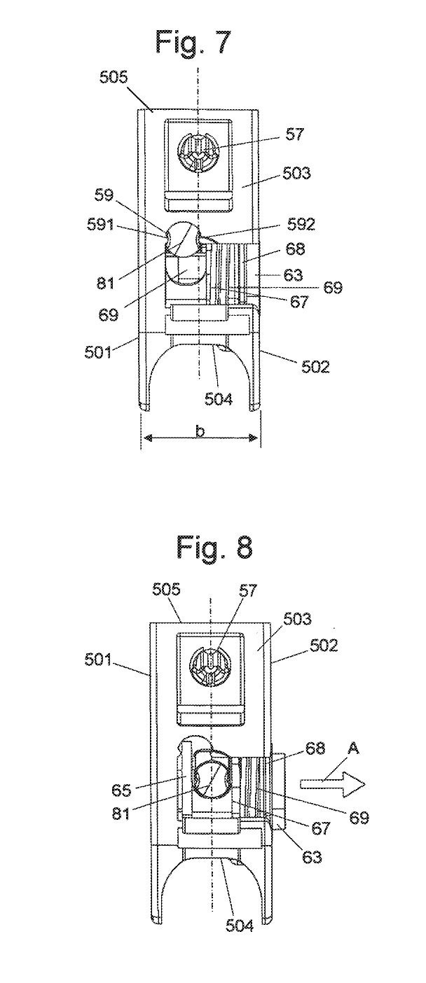

Furthermore, a pitch-circle-shaped coulisse receptacle 59 adapted to the diameter of the unlocking pin 8 as shown in FIGS. 7 and 8 with diametrically opposed protrusions 591, 592 serves for accommodating the unlocking pin 8, on which diametrically opposed grooves 83, which are adapted to the shape of the protrusions 591, 592 of the coulisse receptacle 59, are provided for positively accommodating the unlocking pin 8 in the preassembly position.

For manufacturing the preassembled functional assembly 4, which can be inserted as preassembled group into the upper rail 11 of a rail adjustment system for motor vehicle seats, the cam unlocker 6 with the leg spring 9 put onto the spring bearing 69 between the circumferential limiting webs 67, 68 is put into the pot-like recess 50 of the housing, and via the insertion bevel 58 the unlocking pin 8 is inserted into the opening between the pot-like recess 50 and the integrally molded eccentric surface of the cam unlocker 6 of the housing 5. Subsequently, by means of a screwing movement, the cam unlocker 6 is connected with the side wall 501 of the housing 5 by the connection of the form-fit elements 71-73 and counter form-fit elements 74-76, and is locked in the preassembly position by mutually blocking with the unlocking pin 8 and pretensioned by tensioning the leg spring 9 during the screwing movement.

The positive locking of the cam unlocker 6 on the side wall 501 of the housing 5 in the manner of a bayonet lock prevents an inclination of the cam unlocker 6 about the Z-axis of the motor vehicle system of coordinates and hence a tilting of the cam unlocker 6 because of the point of force application by the pretensioned torsion spring 9 located far away from the bearing point, and ensures a safe anchorage of the cam unlocker 6 in the preassembly position, in which according to FIG. 7 the trunnion 63 of the cam unlocker 6 terminates flush with the side wall 502, so that the functional assembly 4, whose width b corresponds to the width dimension of the upper rail 11, can easily be inserted into the upper rail 11. Due to the locking of the cam unlocker 6 at the side wall 501 of the housing 5, tilting of the cam unlocker 6 is not possible, so that on insertion of the functional assembly 4 into the upper rail lithe trunnion 63 of the cam unlocker 6 is aligned with a corresponding bore in the upper rail 11.

When establishing the preassembly position of the functional assembly 4 by means of a screwing movement of the cam unlocker 6, until there is a mutual engagement of the form-fit elements 71 to 73 and counter form-fit elements 74 to 76 against the action of the leg spring 9, whose first spring leg 90 rests against the first spring leg stop 54, the unlocking pin 8 is pressed out of its operating position shown in FIG. 8 into the preassembly position shown in FIG. 7, in which the locking pin 8 is accommodated in the coulisse receptacle 59.

In this preassembly position there is a mutual locking of the cam unlocker 6 and the unlocking pin 8, wherein the locking pin 8 is secured by the coulisse receptacle 59 and by the eccentric surface of the cam unlocker 6 and cannot back away in Y-direction of the motor vehicle system of coordinates. In addition, the unlocking pin 8 is held in the preassembly position by the bent spring tab 51 of the housing 5, which rests against its actuating head 80. In this preassembly position, a rotation of the cam unlocker 6 against the screwing movement for establishing the preassembly position is not possible as a result of the form-fit elements 71 to 73 and counter form-fit elements 74 to 76 engaging in each other in conjunction with the positioning of the unlocking pin 8 in the coulisse receptacle 59 and the resulting blockage of the cam unlocker 6.

To illustrate the displacement of the unlocking pin 8 from the operating position shown in FIG. 8 into the preassembly position shown in FIG. 7, the line of symmetry of the housing is indicated in each of FIGS. 7 and 8.

With reference to FIGS. 9 and 10, the insertion and connection of the functional assembly, which is in the preassembly position as shown in FIG. 7, in the upper rail 11 of a rail adjustment system will be explained below.

As shown in FIG. 9, the functional assembly 4 is inserted into the upper rail 11 until abutment of the stop 53 against a steel guide piece 15 of the upper rail 11 and by pressure in the front region of the housing 5 adjoining the second end wall 504, the unlocking pin 8 is moved upwards in direction of the arrow B against the spring force of the bent spring tab 51. The further mounting movement is facilitated by the abutment of the stop 53 against the steel guide piece 15 and by the insertion radius 52 on the bottom wall 502 of the housing 5. By further pressure on the housing 5, the connecting pin 57 gets into the clip hole 13 of the upper rail 11. Hence, the functional assembly 4 is positioned, i.e. the cam unlocker 6 is located before the bearing hole 14 aligned with the trunnion 63 in the upper rail 11.

With the linear movement of the unlocking pin 8 in direction of the arrow B the same leaves its blocking position in the coulisse receptacle 59. Due to the pretension of the leg spring 9 in the preassembly position with abutment of the first spring leg 90 against the first spring leg stop 54, a torque is exerted on the cam unlocker 6 in direction of the arrow C. Due to the cancellation of the blockage of the unlocking pin 8, a rotary movement of the cam unlocker 6 in direction of arrow C hence is possible, wherein the rotary movement is initiated by the leg spring 9. With the rotary movement of the cam unlocker 6 opposite to the screwing movement of the cam unlocker 6 for establishing the preassembly position, the form-fit elements 71 to 73 and counter form-fit elements 74 to 76 get out of engagement, so that by releasing the cam unlocker 6 the same moves in direction of the arrow A, according to FIG. 8 in Y-direction of the motor vehicle system of coordinates, and at the same time the unlocking pin 8 moves into the central plane of the housing 5 and hence of the upper rail 11 according to FIG. 8. The bent spring tab 51 urges the unlocking pin 8 in direction of the bearing hole 14 in the upper rail 11 according to FIG. 10.

In a further mounting step, the unlocking pin 8 and the connecting pin 57 must be depressed in the region of the first end wall 505 by means of a pressing device 16 in the region of the points designated by the arrows D and E on the upper side of the housing 5. At the same time, the cam unlocker 6 is rotated in direction of the arrow F, i.e. in clockwise direction, against the spring force of the leg spring 9 enclosing the cam unlocker 6. When being pressed into the bearing hole 14, the unlocking pin 8 is threaded into the bearing hole 14 in a movement similar to the shape of an S as a result of the eccentric surface 66 of the cam unlocker 6 resting against the actuating head 80 of the unlocking pin 8. Hence, the unlocking pin 8 is in the locking position of the actuating device as shown in FIG. 1.

Due to the provision of a functional or preassembled group 4 in a preassembly position, the insertion of the functional assembly 4 into the upper rail 11 of a rail adjustment system thus merely consists of a joining movement of the functional assembly 4 including a depression of the functional assembly 4 and a clipping in with subsequent depression of the connecting pin 57 and the unlocking pin 8 by means of a pressing device 16. The joining direction of the unlocking pin 8 into the bearing hole 14 of the upper rail 11 is achieved via the spring pretension of the functional assembly 4. Alternatively, there can be used a device which for example engages into the frontal contour of the cam unlocker 6 and introduces the required rotary movement from outside.

FIG. 11 shows an enlarged detail representation of the jamming of a shoulder 570 formed at the connecting pin 57 at an edge of the clip hole 13 in the upper rail 11 on insertion of the functional assembly 4 into the upper rail 11 before and during the depression of the functional assembly 4 and the clipping in with subsequent depression of the connecting pin 57 and the unlocking pin 8 by means of a pressing device 16.

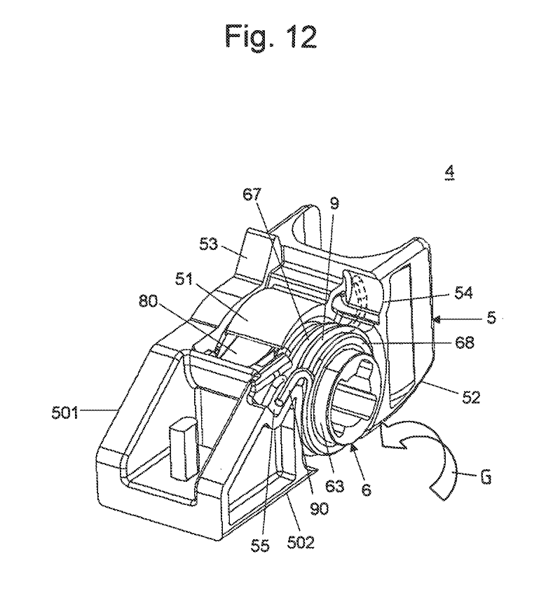

FIG. 12 shows a perspective representation of the functional assembly 4 in the position of use or operating position with the unlocking pin 8 in the retracted locking position.

For unlocking the locking device from the locking position shown in FIG. 1, the cam unlocker 6 is rotated in direction of the arrow G of FIG. 11 in anticlockwise direction, so that the unlocking pin 8 is extended through the eccentric surface of the cam unlocker 6 and pivots the unlocker comb 31 for lifting the locking bolts 2 out of their locking with the lower rail 12. As in the end region of the working angle of the cam unlocker 6 the restoring moment becomes very small, because the spring forces of the unlocker comb 31 and the spring elements resting against the locking bolts 2 act on the cam unlocker 6 via the unlocking pin 8 and the pitch is close to self-locking, the first spring leg 90 of the leg spring 9 is brought in abutment with the second spring leg stop 55 of the housing 5 from a defined angle of rotation of the cam unlocker 6 and hence the leg spring 9 is coupled in and tensioned during the further rotation of the cam unlocker 6. Hence, resetting of the cam unlocker 6 is ensured when for leaving the unlocked position of the locking device and for transition into the locking position the unlocking pin 8 is moved back into the locking position shown in FIG. 11.

The exemplary embodiment shown in FIGS. 3 to 12 and described above correspondingly is also applicable to other types of actuating devices for unlocking locking bolts 2 from a locking position. When the actuating device for example includes a manually or electromotively actuatable unlocking lever, which lifts the unlocker comb 31 out of the locking position against the spring pretension of the locking bolts 2, the unlocking lever instead of the unlocking pin 8 can be accommodated in the functional assembly 4. The unlocking pin 8 also can be formed as part of the unlocking lever and be connected with the same after inserting the functional assembly 4 into the upper rail 11.

1-19. (canceled)

20. An actuating device for a locking means of a longitudinal adjusting means of a motor vehicle seat with upper and lower rails engaging in each other and longitudinally adjustable relative to each other, between which a cavity is formed, wherein the actuating device comprises actuating elements for unlocking the locking means pretensioned in locking direction, wherein the actuating elements are combined to a functional assembly which can be inserted into the cavity between the upper and lower rails, is connectable with the locking means and can be brought into an operating position for actuating the locking means on insertion into the cavity between the upper and lower rails and connection with the locking means.

21. The actuating device according to claim 20, wherein the actuating elements in the functional assembly are pretensioned and locked in the pretensioned position, and that on connecting the functional assembly with the locking means the locking of the actuating elements is canceled and the pretension of the actuating elements is released when the operating position of the functional assembly is taken.

22. The actuating device according to claim 20, wherein the actuating elements include an unlocking pin for unlocking the locking means pretensioned in locking direction, a cylindrical cam unlocker with integrally molded eccentric surface for actuating the unlocking pin and a leg spring placed around the cam unlocker, which are combined in a housing to form the functional assembly which for taking the operating position with the locking means can be inserted into the cavity between the upper and lower rails.

23. The actuating device according to claim 20, wherein in a preassembly position in which the unlocking pin and the cam unlocker are pretensioned and locked at the housing the functional assembly can be positively inserted into the cavity between the upper and lower rails during connection with the locking means by releasing the pretension and locking and by taking the operating position.

24. The actuating device according to claim 20, wherein the locking means includes a number of locking bolts pretensioned in locking direction of the upper and lower rails and an unlocker comb pivotable about a pivot pin, which for unlocking the locking bolts by means of the unlocking pin is pivotable in an unlocking position of the locking bolts.

25. The actuating device according to claim 20, wherein the cam unlocker is mounted on a first side wall of the housing with a rear end face and that for adjusting the preassembly position the rear end face of the cam unlocker is connectable with the first side wall of the housing with a radially and axially directed screwing movement against the spring force of the leg spring.

26. The actuating device according to claim 25, wherein during the screwing movement of the cam unlocker the unlocking pin aligned vertically to the axis of the cam unlocker is moved from an operating position into a coulisse receptacle of the housing and is mutually locked with the cam unlocker, wherein the unlocking pin blocks a rotation of the cam unlocker against the screwing movement connecting the cam unlocker with the first side wall of the housing and a trunnion formed on the front end face located opposite the rear end face of the cam unlocker terminates at least flush with the second side wall located opposite the first side wall of the housing.

27. The actuating device according to claim 20, wherein a first spring leg of the leg spring is connected with the cam unlocker and in the preassembly position a second spring leg of the leg spring rests against a first spring leg stop of the housing and that for establishing the preassembly position the leg spring is tensioned by means of the screwing movement of the cam unlocker.

28. The actuating device according to claim 20, wherein the rear end face of the cam unlocker and the first side wall of the housing include form-fit elements and counter form-fit elements engaging in each other for axially and radially fixing the cam unlocker.

29. The actuating device according to claim 28, wherein at least a part of the form-fit elements and counter form-fit elements is formed in the manner of a bayonet lock, preferably with rear grip, which is closed by a screwing movement of the cam unlocker in the one direction of rotation and is opened in the opposite direction of rotation.

30. The actuating device according to claim 28, wherein further form-fit elements and counter form-fit elements consist of screw surfaces on the first side wall of the housing and counter screw surfaces cooperating with the screw surfaces on the rear end face of the cam unlocker.

31. The actuating device according to claim 20, wherein in the preassembly position the actuating head of the unlocking pin opposite the actuating tip of the unlocking pin rests against a spring tab of the housing.

32. The actuating device according to claim 20, wherein the housing comprises
a trunnion accommodating the cam unlocker on the first side wall,
the form-fit elements radially spaced from the trunnion for connection with the counter form-fit elements of the rear end face of the cam unlocker,
adjacent to a first end wall a connecting pin protruding from the bottom wall to be connected with an adjustable part of the adjusting device, which in the operating position of the actuating device engages into an opening of the adjustable part,
a second spring leg stop against which the second spring leg of the leg spring rests in the operating position of the actuating device,
a preferably bent spring tab partly enclosing the shell surface of the cam unlocker,
an insertion bevel between the bottom wall and the second end wall opposite the first end wall, and
a stop protruding from the upper side of the housing adjacent to the first end wall.

33. The actuating device according to claim 20, wherein the cam unlocker comprises
the bearing bore on the rear end face, which together with the trunnion of the housing forms a pivot bearing of the cam unlocker,
the counter form-fit elements spaced from each other radially from the bearing bore and in circumferential direction of the rear end face for connection with the form-fit elements on the first side wall of the housing,
a bore arranged in the peripheral surface for accommodating the second spring leg of the leg spring, and
circumferential limiting webs axially spaced from each other in the peripheral surface, which between themselves form the cylindrical spring bearing for accommodating the leg spring.

34. A method for manufacturing a preassembled functional assembly of the actuating device according to claim 20, wherein
the cam unlocker with the leg spring put onto the spring bearing is put into the recess of the housing formed between the side walls of the housing,
the unlocking pin is inserted into the between the wall of the recess and the integrally molded eccentric surface of the cam unlocker via an insertion bevel of the housing, and
by means of a screwing movement the cam unlocker is connected with the first side wall of the housing by the connection of the form-fit elements and counter form-fit elements and locked in the preassembly position by mutually blocking with the unlocking pin.

35. A method for mounting the preassembled functional assembly of the actuating device into a longitudinal adjusting means for a motor vehicle seat, which contains upper and lower rails engaging in each other and longitudinally adjustable relative to each other, with a locking means which includes a number of locking bolts pretensioned in locking direction of the upper and lower rails and an unlocking comb pivotable about a swivel axis, which for unlocking the locking bolts by means of the unlocking pin is pivotable in an unlocking position of the locking bolts, wherein in a first mounting step
the functional assembly is inserted into the upper rail until abutment of the stop of the housing against a part (steel guide piece) of the upper rail,
the unlocking pin is moved in direction of the upper side of the housing by pressure onto the front region of the housing adjoining the second end wall, against the spring force of the bent spring tab of the housing,
by further pressure onto the housing, the connecting pin engages into a clip hole of the upper rail and the trunnion of the cam unlocker is aligned with a bearing hole in a side wall of the upper rail,
with the linear movement, the unlocking pin leaves its blocking position in the coulisse receptacle,
due to the pretension of the leg spring in the preassembly position or by a tool engaging into the profiled structure in the front end face of the cam unlocker a torque is exerted on the cam unlocker in anticlockwise direction, wherein by cancelling the blockage of the unlocking pin a rotary movement of the cam unlocker is effected in clockwise direction, which is triggered by the leg spring or the tool,
with the rotary movement of the cam unlocker opposite to the screwing movement of the cam unlocker for establishing the preassembly position, the form-fit elements and counter form-fit elements get out of engagement and release the cam unlocker,
the cam unlocker moves in Y-direction of the motor vehicle system of coordinates, and
the unlocking pin moves into the central plane of the housing, wherein the bent spring tab of the housing urges the unlocking pin in direction of a bearing hole for the unlocking pin in the upper rail.

36. The method according to claim 35, wherein in a second mounting step
the unlocking pin and the connecting pin are depressed by means of a pressing device attached in the region of the upper side of the housing and at the same time the cam unlocker is rotated in clockwise direction against the spring force of the leg spring enclosing the cam unlocker, and
when being pressed into the bearing hole of the upper rail, the unlocking pin is threaded into the bearing hole in a movement similar to the shape of an S as a result of the eccentric surface of the cam unlocker resting against the actuating head of the unlocking pin, in which bearing hole it is in the locking position of the actuating device.
